(19) United States
(12) Patent Application Publication
(10) Pub. No.: US 2015/0269328 A1
(43) Pub. Date: Sep. 24, 2015

(54) SCHEDULE OPTIMIZATION AND ONLINE BOOKING SYSTEM FOR HEALTHCARE PRACTICES

(71) Applicants: Paul Wiley, Colleyville, TX (US); Matthew Levine, Winter Park, FL (US); Aaron Lloyd, Dallas, TX (US)

(72) Inventors: Paul Wiley, Colleyville, TX (US); Matthew Levine, Winter Park, FL (US); Aaron Lloyd, Dallas, TX (US)

(21) Appl. No.: 14/221,415

(22) Filed: Mar. 21, 2014

(51) Int. Cl. G06F 19/00

(52) U.S. Cl. CPC G06F 19/327

(57) ABSTRACT

A system and/or process for scheduling patients in a medical practice may be adapted to achieve a set of predetermined scheduling goals of the practice. Such a system may involve collecting a set of scoring parameters for scoring a patient and assigning a numerical quantity to each scoring parameter according to a set of predetermined scoring rules. A patient score may be calculated as an average of the scoring parameters. A set of patient score ranges may be defined to categorize patients into a set of classes (i.e. patient buckets) based on their score. Time ranges may be defined relative to the present time (i.e. time of scheduling) wherein each range is associated with a set of scheduling rules governing the allowed ratio of patients from each patient bucket. A patient may be assigned to a given appointment time slot provided that no scheduling rules are violated thereby.

### I. BACKGROUND OF THE INVENTION

A. Field of Invention

Some embodiments may generally relate to the field of scheduling patients in a medical practice.

B. Description of the Related Art

Various scheduling software programs and systems are known in the art including systems specifically made for use by medical practices. However, existing systems have a number of drawbacks and inefficiencies that may cause medical practitioners to fall short of their professional or business goals due to scheduling patients according to less than optimal methodologies. Many existing systems fail to allow practitioners or their agents to prioritize patients according to rules calculated to achieve certain predefined goals which may or may not be monetary in nature, and which may be unique to the particular practice. Furthermore, existing systems require complex algorithms to prioritize patients, and the algorithms may still yield less than optimal results relative to the practitioner's individual goals. What is needed is a system that may be configured on a case by case basis to suit the particular needs of a given medical practice, and which is relatively simple to use and may be offered according to a software as a service (SaaS) model.

Some embodiments of the present invention may provide one or more benefits or advantages over the prior art.

### II. SUMMARY OF THE INVENTION

Some embodiments may relate to a process for scheduling patients in a medical practice to achieve a set of predetermined scheduling goals of the practice, comprising the steps of collecting a set of scoring parameters for scoring a patient; assigning a numerical quantity to each scoring parameter according to a set of predetermined scoring rules; calculating a patient score as an average of the scoring parameters; defining a set of patient score ranges, each range comprising a patient bucket; assigning the scored patient to a patient bucket according to the patient's score; dividing available appointments into time ranges measured relative to the present time, wherein each time range is associated with a set of rules governing the allowed percentage of patients from each patient bucket; and assigning the scored patient to an appointment without violating any rules governing the allowed percentage of patients from each patient bucket.

Embodiments may further comprise the step of providing a means for manually overriding the process.

According to some embodiments if a plurality of patients is being scheduled simultaneously the process further comprises the step of prioritizing the plurality of patients according to their patient bucket assignment.

According to some embodiments if any two patients are assigned to the same bucket, the process further comprises the step of prioritizing those patients according to their patient score.

According to some embodiments if a plurality of patients is being scheduled simultaneously the process further comprises the step of prioritizing the plurality of patients according to their patient score.

According to some embodiments the step of assigning the scored patient further comprises assigning the scored patient to the earliest available appointment.

According to some embodiments the step of assigning the scored patient further comprises provisionally assigning the scored patient to a manually selected appointment time, checking whether the provisional assignment violates any rules governing the allowed percentage of patients from each patient bucket, and either non-provisionally assigning the scored patient to the manually selected appoint time, or revoking the provisionally assigned appointment time.

Some embodiments may relate to a process for scheduling patients in a medical practice to achieve a set of predetermined scheduling goals of the practice, comprising the steps of: collecting a set of scoring parameters for scoring a patient; assigning a numerical quantity to each scoring parameter according to a set of predetermined scoring rules; calculating a patient score as an average of the scoring parameters; defining a set of patient score ranges, each range comprising a patient bucket; assigning the scored patient to a patient bucket according to the patient's score; dividing available appointments into time ranges measured relative to the present time, wherein each time range is associated with a set of rules governing the allowed percentage of patients from each patient bucket; assigning the scored patient to an appointment without violating any rules governing the allowed percentage of patients from each patient bucket, wherein if a plurality of patients is being scheduled simultaneously the process further comprises the step of prioritizing the plurality of patients according to their patient score; and providing a means for manually overriding the process.

According to some embodiments the step of assigning the scored patient further comprises assigning the scored patient to the earliest available appointment.

According to some embodiments the step of assigning the scored patient further comprises provisionally assigning the scored patient to a manually selected appointment time, checking whether the provisional assignment violates any rules governing the allowed percentage of patients from each patient bucket, and either non-provisionally assigning the scored patient to the manually selected appoint time, or revoking the provisionally assigned appointment time.

Some embodiments may relate to a system for scheduling patients in a medical practice to achieve a set of predetermined scheduling goals of the practice, comprising: a local general purpose computer workstation adapted to collect a set of scoring parameters for scoring a patient through a user interface and communicate said parameters to a remote computer system through an Internet connection; electronic media adapted to record the set of scoring parameters, the electronic media being in data communication with the remote computer system; a scoring engine adapted to assign a numerical quantity to each scoring parameter according to a set of predetermined scoring rules, calculate a patient score, and assign a scored patient to a patient bucket according to the patient's score, the scoring engine being operable by the remote computer system; a scheduling engine operable on the remote computer system and adapted to receive calendar data including open appointment slots from the local general purpose computer workstation or from a second remote computer system, divide the available appointments into time ranges measured relative to the present time, wherein each time range is associated with a set of rules governing the allowed percentage of patients from each patient bucket, and the scheduling engine being further adapted to assign the scored patient to an appointment without violating any rules governing the allowed percentage of patients from each patient bucket; and means for transmitting the assignment of the scored patient to the appointment back to the local general purpose computer workstation.

According to some embodiments the local general purpose computer workstation is further adapted to record the scoring parameters in a local database.

According to some embodiments the remote computer system is a cloud system of a plurality of networked computers.

According to some embodiments the electronic media is physically located on one or more of the plurality of networked computers.

According to some embodiments the scoring engine calculates a patient score according to an arithmetic mean, a geometric mean, a weighted arithmetic mean, or a weighted geometric mean.

According to some embodiments the second remote computer system comprises computer media owned or leased by a medical practitioner.

According to some embodiments the scheduling engine further comprises a means for overriding the scheduling rules at the option of an authorized user of the system.

Other benefits and advantages will become apparent to those skilled in the art to which it pertains upon reading and understanding of the following detailed specification. The description and claims contained herein may refer to process steps using words that imply the order of steps such as “after” or “then”, for example. However, these words are not intended to limit the order of steps except where a particular order is necessary to the process.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a flow chart illustrating a process according to an embodiment of the invention;

FIG. 2 is a graphical illustration of scoring parameter states shown relative to each other;

FIG. 3A is a schematic drawing of a SaaS system according to an embodiment of the invention; and

FIG. 3B is a schematic drawing of a SaaS system according to a cloud-based embodiment.

### IV. DETAILED DESCRIPTION OF THE INVENTION

Embodiments of the invention generally relate to processes and systems for optimizing selected goals of a medical practice by applying certain steps to scheduling patients. In general, a process according to the invention includes collecting a set of scoring parameters from a patient which will be used to calculate a score for the patient. Patients are then prioritized by grouping them into classes based upon the range within which their score falls. Available appointment times are divided into time ranges, and each range is associated with a set of rules governing the allowed proportion of each patient class. Patients may then be assigned to an appointment based on, for example, the earliest available time that can be assigned without violating the proportioning rules associated with any appointment time range.

The step of defining a set of scoring parameters of an embodiment generally occurs during the configuration phase of implementation. While the specific set of scoring parameters included in any given embodiment may be different from one embodiment to the next, an exemplary and non-limiting list of scoring parameters may include one or more of (1) whether a requested appointment time is adjacent to another scheduled appointment, (2) whether the CPT code describing the subject matter of a requested appointment is the same as that of an adjacent appointment, (3) whether the requested appointment is with the patient's primary physician, (4) the office location where the appointment is requested to be held (e.g. if the physician has more than one office, one may be preferred), (5) whether the appointment request if for a specific date/time or for a first available date/time, (6) the number of days in advance that the appointment is requested, (7) a near term revenue loss prevention parameter whereby open appointment slots within 36 hours of the time of scheduling may afforded preference based on whether they are viewed as high risk-of-loss, (8) an intra-business day revenue loss prevention parameter, (9) the degree of attractiveness of an appointment time slot, (10) the patient bucket to which the patient has been assigned, (11) whether the patient is designated as a high-value referral, (12) whether the patient is a new or existing patient, (13) the medical urgency of the requested medical care, and (14) the preference, degree of preference, or lack of preference for the requested medical procedure. Each scoring parameter may have one or more possible states. As used herein, the state of a scoring parameter may include quantitative and/or qualitative data. For instance, CPT code parameter may have a plurality of possible states define by specific alphanumeric CPT codes. A medical urgency scoring parameter may have possible states consisting of qualitative information such as “low”, “normal”, and “high” or may consist of a numerical value, e.g. one through 10, indicating urgency.

During configuration, a consultant may select a suitable set of scoring parameters, such as one or more from the foregoing list, and may assign numerical scores to each possible state of each variable. By way of example, the Table 1 is provided to illustrate the relationship between scoring parameters, scoring parameter states, and score values. The states and scores provided are merely illustrative and not intended to be limiting. In some embodiments a score may be assigned according to a formula. For instance, in Table 1 the scoring parameter referred to as First Available Appointment has states which are defined by the number of days between an open appointment slot and the day of scheduling. Thus, the state “5 Days” would indicate that the appointment is being scheduled five days prior to the appointment date. The corresponding score for the states of this scoring parameter derives from a continuous range between zero and 10. An exponential smoothing function may be used to allocate points to scoring parameter states where six months from the scheduling date is worth zero points and one day from the scheduling date is worth 10 points.

TABLE 1
Scoring Rules

| Scoring Parameter | State | Score |
|---|---|---|
| Expected Revenue Demand Curve | Appointment Available | 20 |
| | Appointment Not Available | −30 |
| Scheduling Adjacency | Adjacent | 5 |
| | Not Adjacent | 0 |
| CPT Scheduling Adjacency | Adjacent | 5 |
| | Not Adjacent | 0 |
| Primary Physician | Primary | 1 |
| | Not Primary | 0 |
| Office Location | Main Office | 5 |
| | Satellite Office | 0 |
| Earliest Available Appointment | X Days (X equals the number of days between the | 0-10 |
| | appointment date and the time of scheduling) | |
| Near Term Revenue Loss Risk | High | 50 |
| | Normal | 0 |
| Intra-day Revenue Loss Risk | High | 50 |
| | Normal | 0 |
| Popularity of Time Slot | Popular High (sum of other scoring parameters >= X) | 20 |
| | Popular Low (sum of other scoring parameters <= X) | −30 |
| | Neutral High (sum of other scoring parameters >= Y) | 10 |
| | Neutral Low (sum of other scoring parameters <= Y) | −30 |
| | Unpopular (sum of other scoring parameters = any value) | 0 |
| Referral | High Value | 10 |
| | Normal Value | 5 |
| Patient Status | New Patient | 10 |
| | Returning Patient | 0 |

In general, a patient scoring parameter range may include a set of discrete values rather than a continuous range. The values of a scoring parameter range may be referred to herein as states, assignable values, and/or allowed values. The values may include integers including zero, fractional, irrational numbers, positive or negative numbers, and/or string data. Furthermore, embodiments may take an arbitrary number of decimal places into account as necessary to discriminate between patient scores.

The magnitude of a range of possible values may be determined based upon several factors including the number of unique states that a parameter may take on, a numerical value or weighting factor of each state of the parameter, and a numerical value or weighting factor of the maximum and minimum states of the parameter relative to the maxima and minima of other parameters. For instance, the range of a parameter, e.g. Medical Urgency, may have a minimum state that is descriptive of routine matters that can be scheduled weeks or even months in advance, and a maximum state that is descriptive of life-threatening matters which must be handled immediately.

Continuing with the example of the Medical Urgency parameter, a state may be defined solely by one or more empirically determined quantitative components, and it may include one or more qualitative components represented by, for instance, string variables. Furthermore, Medical Urgency may include a relatively large number of unique states between a maximum state and a minimum state. The quantitative component(s) of each of the various states may characterize their relative importance to making a scheduling decision as compared to other states of the Medical Urgency parameter. Thus, the quantitative component(s) of each state may comprise a statistical weighting factor. Accordingly, a quantitative range of states may be determined by the maximum and minimum values of the quantitative components and/or weighting factors of each state of the Medical Urgency parameter. Furthermore, the number of possible states of the Medical Urgency parameter may be determined by the number of states necessary to distinguish between the levels of urgency of every case that could be treated in a medical given practice. One skilled in the art will appreciate that each scoring parameter may have a unique range and number of states. Accordingly, the maximum and/or minimum states of one scoring parameter may be different from that of another scoring parameter.

In one example scoring parameters having different maxima and minima may include reimbursement parameters versus medical urgency. A reimbursement parameter may include states indicating whether the patient is self-pay, indigent, Medicare, or is insured with one of a predetermined set of insurance plans having known compensation rules. The reimbursement parameter may include a qualitative component indicating which of the foregoing modes of payment it represents, and a quantitative component indicating its level of importance to making a scheduling decision. In one embodiment, appropriate ranges for a Medical Urgency parameter and a Compensation may be configured so that a Medical Urgency state overrides the effect of a minimum Compensation state, and thus may allow an indigent patient access to a same day appointment if the level of medical urgency is sufficiently high.

With further regard to appropriate ranges for scoring parameters, the minimum value of every range need not be zero. A scoring parameter having a minimum state value representing a global minimum value among all scoring parameters, may be set to an arbitrary minimum such as zero. Thus, other scoring parameter ranges may have positive non-zero minima. Similarly, the maxima of each scoring parameter range may be scaled relative to a global maximum.

After an embodiment's scoring parameter states are associated with numerical scores, the embodiment may be used to prioritize patients beginning with the collection of scoring data from patients. Collection of scoring data can include inputting the parameter data into a general purpose computer suitably programmed with an interface for accepting the data. Scoring parameter data so entered may be communicated to a database for storage and later retrieval and/or may be applied to one or more scoring algorithms. The step of collecting scoring parameter data may further include checking data already recorded in the patient's record each time a patient requests an appointment, thereby verifying its accuracy and alerting the provider to changes that may have occurred since the last appointment. Thus, as used herein “collecting scoring parameters” can mean obtaining up to a full set of scoring parameter states from a new patient, but may also mean supplementing, verifying, and/or updating an existing data set of a current patient.

A patient score may be calculated as an arithmetic mean (eq. 1) of score values. For instance, in one example using three arbitrary values, a patient score of “3.3333” may be calculated as an arithmetic mean by applying eq. 1 to the data from Table 2 as follows, which sets forth mock data of a fictitious patient.

$${\overline{x}}_{arth} = \frac{1}{n} ( {x}_{1} + {x}_{2} … {x}_{n} ) ; \qquad ( eq . 1 )$$

TABLE 2
Example Patient Scoring Data

| Scoring Parameter and State | Score Value |
|---|---|
| Medical Urgency: low | 5 |
| Compensation: Medicare | 2 |
| CPT Code: 3006F | 3 |

$${\overline{x}}_{arth} = \frac{1}{3} ( 5 + 2 + 3 ) = 3. \overline{3333}$$

The foregoing example is not intended to represent appropriate states, suitable maxima/minima, or suitable increments for values of the respective ranges to which each parameter relates. These specific values are arbitrarily chosen for the purpose of illustrating a method of calculation based on a set of patient data. Furthermore, the invention is not limited to calculating a patient score as an arithmetic mean, but rather may include other mathematical methods capable of producing a similarly suitable scoring result that allows comparison of patient to another.

Patient classes, referred to hereinafter as “buckets”, are defined as ranges of patient scores. Thus, a patient score falling within the range of a first patient bucket would be assigned to the first bucket, and a score falling within the range of a second patient bucket would be assigned to the second bucket. A set of scheduling rules may be applied to schedule patients according to their bucket type. Thus patients falling within the same bucket are scheduled according to the same rules. In some embodiments, patients may be scheduled on a first come first served basis, meaning each patient is scheduled according to the set of open appointments existing at the moment of scheduling without regard the scores of other patients. Thus, in such embodiments patients do not compete for appointments. However, embodiments are contemplated wherein persons being scheduled may compete for an appointment based on their score and/or bucket type.

Embodiments divide available appointment slots into configurable time ranges measured relative to the time of scheduling. Furthermore, scheduling rules may operate relative to the time of scheduling. Therefore, rather than associating a given rule with a particular calendar day (e.g. Aug. 4, 2014), an embodiment may associate a given rule with a date and/or time measured relative to the present, i.e. the time of scheduling. Thus, a given rule may for instance apply to the day of scheduling, first appointment of the next business day, noon to 1:00 PM of any future business day, certain traditionally popular time slots, and so on without regard to a calendar date. Rule sets thereby apply to different dates and times as time advances. Accordingly, the availability of a given time slot to a given bucket type may change as an open appointment slot approaches the present time (time of scheduling).

Scheduling rules may determine the percentage of patients from each bucket type which may be scheduled in a given range. More preferred schedule ranges may be associated with scheduling rules that allow for fewer patients from less preferred buckets. Conversely, less preferred schedule ranges may allow for scheduling of more patients from less preferred bucket types, or may at least be less restrictive with regard to percentage of patients allowed from each bucket type. For example, in one embodiment, if an appointment time slot remains unfilled on the day of scheduling then that appointment slot may be available to any bucket type without restriction. In a further example, the scheduling rules of an embodiment may approach an ideal patient bucket type composition as the amount of time increases between an available appointment slot and the time of scheduling. For instance, it may be preferable to some practitioners to schedule patients six months in advance according to rules that reflect his/her ideal patient composition for a given time range, but as the calendar date within the given date range approaches the present time the practitioner may be more willing to make concessions in order to ensure that the appointment time slots are filled. The foregoing example is presented only to illustrate the moving nature of scheduling rules, and is not intended to limit embodiments.

In general, embodiments may be configured to schedule patients for a selected date, and/or for the earliest available date, without violating the relevant scheduling rules governing the allowed percentage of patients from each bucket type. However, embodiments may include means for overriding scheduling rules at the option of the practitioner or his/her authorized agent.

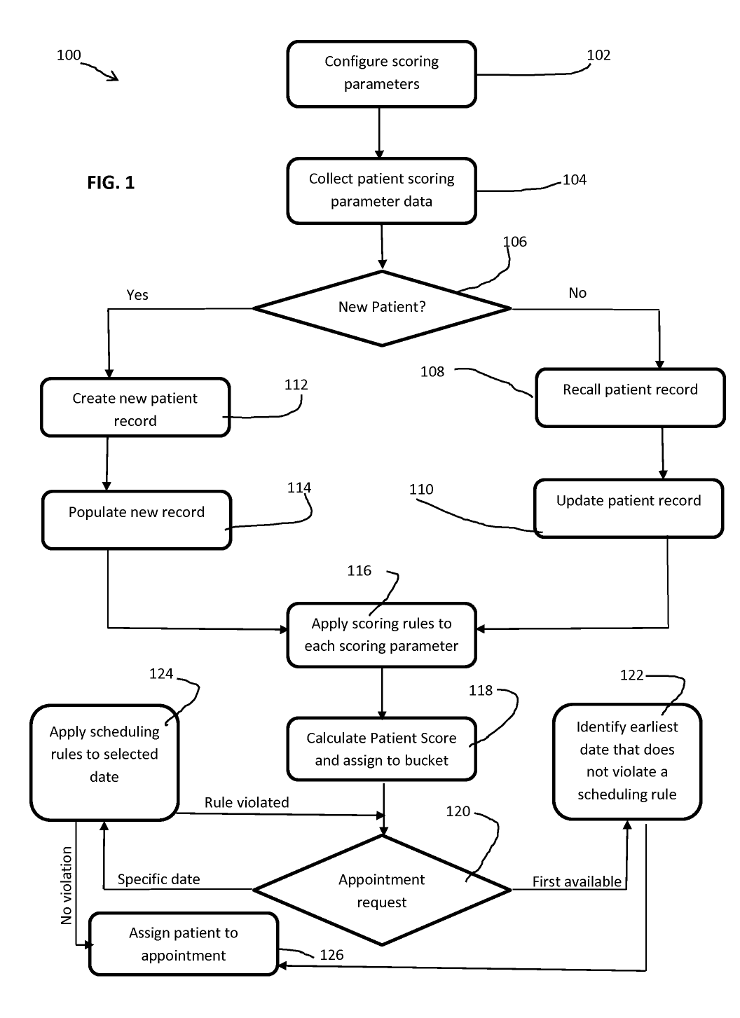

Referring now to the drawings wherein the showings are for purposes of illustrating embodiments of the invention only and not for purposes of limiting the same, FIG. 1 is a flowchart illustrating a process 100 according to one embodiment. The process 100 begins with configuring 102 the scoring parameters of an embodiment. A consultant may confer with the medical practitioner for whom the embodiment is being configured, and may establish a set of goals of the practitioner. The consultant may then apply his judgment to configure a corresponding set of scoring parameters so that the embodiment may automatically schedule patients in accordance with the practitioner's goal set. Configuration may include setting maxima and minima for a scoring parameter, defining scores for discrete states of a scoring parameter, defining continuous ranges of scores for states of a scoring parameter, or any combination thereof.

The step of collecting 104 patient scoring parameter state data occurs after an embodiment is configured. In this step, an operator of the system, such as front-office administrative staff employed by the practitioner, conducts patient intake procedures. The operator may prompt the patient to provide scoring parameter state data such as, without limitation, identifying indicia (e.g. personal name, social security number, etc.), reimbursement type (e.g. self-pay, insurance carrier name, group number, policy number, Social Security, Medicare, Medicaid, indigent, etc.), and the reason for the visit (e.g. annual physical, blood work, x-rays, etc.). The system determines 106 whether the patient is an existing patient or a new patient and accordingly either creates 112 a new record and populates it 114 with the collected state data, or recalls the patient's existing record 108 and updates it 110 with new or changed data. After creating or updating the patient record the system may apply 116 a set of scoring rules to the scoring parameter state data contained therein; the scoring rules having been configured in the configuration step 102. After applying the scoring rules 116 and thus determining numerical values for each scoring parameter state, a patient score is calculated 118. The patient score can then be compared to the predefined patient buckets to determine to which patient bucket the patient should be assigned. According to this embodiment the patient buckets are defined in terms of patient score ranges, where a first patient bucket “Bucket 1” is defined as a patient score “ x̅ₐᵣₜₕ” as calculated by eq. 1 between the limits n_{1,min} and n_{1,max}, and each of the following buckets is similarly defined in terms of non-overlapping ranges where

n_{1,min}>n_{2,min}>n_{3,min} and

n_{1,max}>n_{2,max}>n_{3,max}.

TABLE 3
Patient Bucket Definitions

| Patient Bucket | Bucket Definition |
|---|---|
| Bucket 1 | n_{1,min} ≦ x̅ₐᵣₜₕ ≦ n_{1,max} |
| Bucket 2 | n_{2,min} ≦ x̅ₐᵣₜₕ ≦ n_{2,max} |
| Bucket 3 | n_{3,min} ≦ x̅ₐᵣₜₕ ≦ n_{3,max} |

Having calculated the patient's score and assigned the patient to a patient bucket in step 118, the system now determines 120 whether the patient is requesting a first available appointment or a particular appointment date. If the patient is requesting a first available appointment then the system identifies 122 the earliest date that does not violate a scheduling rule. The patient is then assigned 126 to the identified appointment. However, if the patient has requested a particular date, then the system determines 124 whether assigning the patient to the requested date would violate a scheduling rule. If no violation would occur then the patient is assigned 126 to the requested appointment, but if a scheduling rule violation would result then the system prompts a system operator to request alternative dates and times from the patient. Other embodiments may suggest alternative appointment dates and times based on one or more of (i) times close to the requested appointment, (ii) appointment times that a traditionally difficult to fill, (iii) an appointment time similar to that of the patient's requested time, e.g. if the original request was for 9:00 AM on Tuesday the a suggested alternative might be 9:00 AM on the following Wednesday and/or 9:00 AM on Tuesday of the following week. Embodiments may also allow a patient to change his request to a first available appointment if his requested appointment time is not available.

Scheduling rules according to embodiments of the invention may be defined in terms of allowed numbers or allowed ratios of a patients from each patient bucket that may be assigned to a relative time range. For instance, Table 4 illustrates a partial set of scheduling rules for first appointment of the day written in terms of allowed maximum ratios of each patient bucket type. As shown in Table 4, rule definitions are written as a set of inequalities having the form

$$r \leq \frac{{B}_{n}}{{B}_{tot}} ,$$

where Bₙ represents the maximum number of patients permitted from a bucket n compared to the total number of patients from all buckets Bₜₒₜ. Furthermore, while a separate set of rules is shown for each of four different time ranges, one skilled in the art will appreciate that the rules may be rewritten as a single set of continuous functions of Days in Advance.

TABLE 4
Scheduling Rules

| Scheduling | Days in | Time | |
|---|---|---|---|
| Rule | Advance | Range | Rule Definition |
| First of Day | 0 | 8:00 AM- 9:00 AM | $1.0 \leq \frac{{B}_{1}}{{B}_{tot}} ; 1.0 \leq \frac{{B}_{2}}{{B}_{tot}} ; 1.0 \leq \frac{{B}_{3}}{{B}_{tot}}$ |
| First of Day | 7 | 8:00 AM- 9:00 AM | $1.0 \leq \frac{{B}_{1}}{{B}_{tot}} ; 0.6 \leq \frac{{B}_{2}}{{B}_{tot}} ; 0.4 \leq \frac{{B}_{3}}{{B}_{tot}}$ |
| First of Day | 30 | 8:00 AM- 9:00 AM | $1.0 \leq \frac{{B}_{1}}{{B}_{tot}} ; 0.4 \leq \frac{{B}_{2}}{{B}_{tot}} ; 0.2 \leq \frac{{B}_{3}}{{B}_{tot}}$ |
| First of Day | 180 | 8:00 AM- 9:00 AM | $1.0 \leq \frac{{B}_{1}}{{B}_{tot}} ; 0.2 \leq \frac{{B}_{2}}{{B}_{tot}} ; 0.1 \leq \frac{{B}_{3}}{{B}_{tot}}$ |

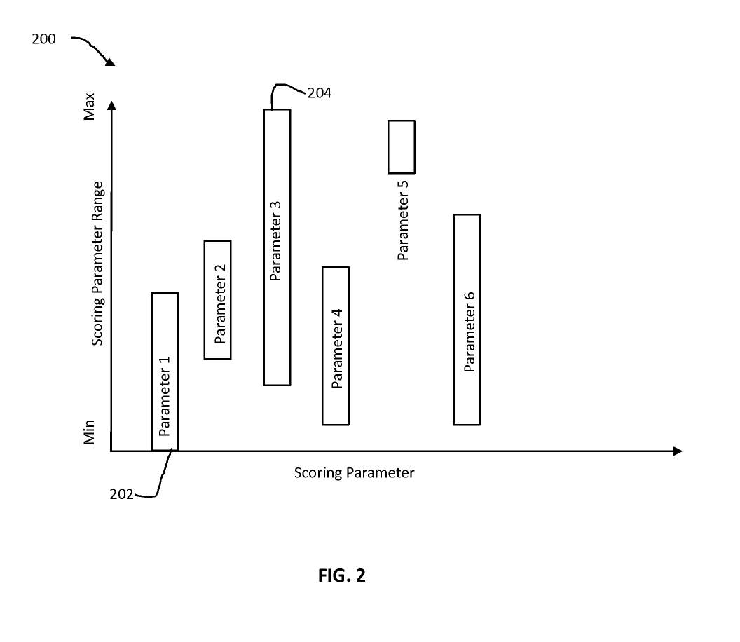

Turning to FIG. 2, a set of arbitrary scoring parameter state ranges is shown 200. The various scoring parameters are generically represented as Parameters 1 through 6. These may include any parameter deemed relevant to prioritizing patients based on the individual goals of a particular medical practitioner. The purpose of this graph is to illustrate the fact that ranges need not all have minima set to zero or maxima set to a single value, and in fact some ranges may not even overlap. Parameter 1, for instance is the only parameter having a minimum value of zero 202. The minima of all other parameters may have been set relative to the minimum value of Parameter 1 202, for instance, by reasoning that even in their lowest state, parameters 2 through 6 are more heavily weighted than some value of Parameter 1. Similarly, Parameter 3 represents a global maximum 204. Thus, all other maxima may have been set relative to the maximum value of Parameter 3 204, for instance, by reasoning that even in their maximum state parameters 1, 2, and 4 through 6 are less heavily weighted than some value of Parameter 3. While the ranges shown in FIG. 2 are represented as continuous, one skilled in the art upon reading the foregoing disclosure will appreciate that the respective ranges may be either continuous or discontinuous, i.e. sets of discrete states.

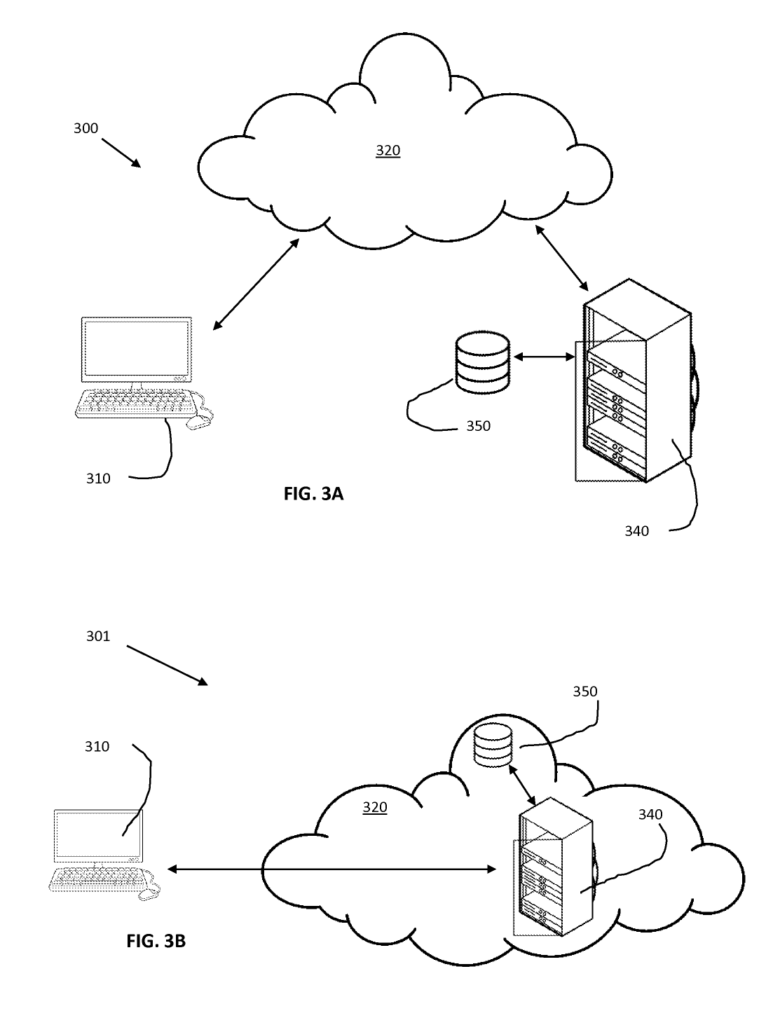

FIG. 3A and FIG. 3B illustrate systems according to two different embodiments. With regard to FIG. 3A, a system 300 is shown comprising a workstation computer 310, which would likely be locally located a physician's office and used by front-office personnel as part of patient intake and check-in procedures. The workstation may be a general purpose personal computer, and may be suitably adapted to receive data inputted through a human interface device such as a keyboard or mouse. Data inputted into the workstation computer 310 is routed through the Internet 320 to a remote server 340 which stores the data on computer-readable media in the form of a database 350. Data recorded in the database 350 may be recalled by the remote server 340 and processed by, for instance, a scoring engine using sets of predefined scoring rules or a scheduling engine using a set of predefined scheduling rules as set forth herein. Parameter scores, patient scores, and/or scheduling rules may also be stored on the computer readable media and/or the database 350. Furthermore, the remote server 340 may communicate with a scheduling program to retrieve available appointment slots. The scheduling program may or may not run on the workstation computer 310; for instance, in some embodiments, the scheduling program may be cloud-based or may run on a remote computer separate from the remote server 340 and/or the workstation 310. The remote server 340 may maintain a real-time or near real-time view of available appointment slots and may assign patients to appropriate appointment slots in accordance with predefined scheduling rules. The remote server 340 may then transmit the scheduled appointment back to the workstation computer 310 and/or the scheduling program using known data transmission devices and software protocols. FIG. 3B shows a variation of the system in FIG. 3A wherein the remote server 340 and database 350 are cloud-based 320.

It will be apparent to those skilled in the art that the above methods and apparatuses may be changed or modified without departing from the general scope of the invention. The invention is intended to include all such modifications and alterations insofar as they come within the scope of the appended claims or the equivalents thereof

Having thus described the invention, it is now claimed:

I/we claim:

1. A process for scheduling patients in a medical practice to achieve a set of predetermined scheduling goals of the practice, comprising the steps of:
collecting a set of scoring parameters for scoring a patient;
assigning a numerical quantity to each scoring parameter according to a set of predetermined scoring rules;
calculating a patient score as an average of the scoring parameters;
defining a set of patient score ranges, each range comprising a patient bucket;
assigning the scored patient to a patient bucket according to the patient's score;
dividing available appointments into time ranges measured relative to the present time, wherein each time range is associated with a set of rules governing the allowed percentage of patients from each patient bucket; and
assigning the scored patient to an appointment without violating any rules governing the allowed percentage of patients from each patient bucket.

2. The process of claim 1 further comprising the step of providing a means for manually overriding the process.

3. The process of claim 1, wherein if a plurality of patients is being scheduled simultaneously the process further comprises the step of prioritizing the plurality of patients according to their patient bucket assignment.

4. The process of claim 3, wherein if any two patients are assigned to the same bucket, the process further comprises the step of prioritizing those patients according to their patient score.

5. The process of claim 1, wherein if a plurality of patients is being scheduled simultaneously the process further comprises the step of prioritizing the plurality of patients according to their patient score.

6. The process of claim 1, wherein the step of assigning the scored patient further comprises assigning the scored patient to the earliest available appointment.

7. The process of claim 1, wherein the step of assigning the scored patient further comprises provisionally assigning the scored patient to a manually selected appointment time, checking whether the provisional assignment violates any rules governing the allowed percentage of patients from each patient bucket, and either non-provisionally assigning the scored patient to the manually selected appoint time, or revoking the provisionally assigned appointment time.

8. A process for scheduling patients in a medical practice to achieve a set of predetermined scheduling goals of the practice, comprising the steps of:
collecting a set of scoring parameters for scoring a patient;
assigning a numerical quantity to each scoring parameter according to a set of predetermined scoring rules;
calculating a patient score as an average of the scoring parameters;
defining a set of patient score ranges, each range comprising a patient bucket;
assigning the scored patient to a patient bucket according to the patient's score;
dividing available appointments into time ranges measured relative to the present time, wherein each time range is associated with a set of rules governing the allowed percentage of patients from each patient bucket;
assigning the scored patient to an appointment without violating any rules governing the allowed percentage of patients from each patient bucket, wherein if a plurality of patients is being scheduled simultaneously the process further comprises the step of prioritizing the plurality of patients according to their patient score; and
providing a means for manually overriding the process.

9. The process of claim 8, wherein the step of assigning the scored patient further comprises assigning the scored patient to the earliest available appointment.

10. The process of claim 8, wherein the step of assigning the scored patient further comprises provisionally assigning the scored patient to a manually selected appointment time, checking whether the provisional assignment violates any rules governing the allowed percentage of patients from each patient bucket, and either non-provisionally assigning the scored patient to the manually selected appoint time, or revoking the provisionally assigned appointment time.

11. A system for scheduling patients in a medical practice to achieve a set of predetermined scheduling goals of the practice, comprising:
a local general purpose computer workstation adapted to collect a set of scoring parameters for scoring a patient through a user interface and communicate said parameters to a remote computer system through an Internet connection;
electronic computer-readable media adapted to record the set of scoring parameters, the electronic media being in data communication with the remote computer system;
a scoring engine adapted to assign a numerical quantity to each scoring parameter according to a set of predetermined scoring rules, calculate a patient score, and assign a scored patient to a patient bucket according to the patient's score, the scoring engine being operable by the remote computer system;
a scheduling engine operable on the remote computer system and adapted to receive calendar data including open appointment slots from the local general purpose computer workstation or from a second remote computer system, divide the available appointments into time ranges measured relative to the present time, wherein each time range is associated with a set of rules governing the allowed percentage of patients from each patient bucket, and the scheduling engine being further adapted to assign the scored patient to an appointment without violating any rules governing the allowed percentage of patients from each patient bucket; and
means for transmitting the assignment of the scored patient to the appointment back to the local general purpose computer workstation.

12. The system of claim 11, wherein the local general purpose computer workstation is further adapted to record the scoring parameters in a local database.

13. The system of claim 11, wherein the remote computer system is a cloud system of a plurality of networked computers.

14. The system of claim 13, wherein the electronic media is physically located on one or more of the plurality of networked computers.

15. The system of claim 11, wherein the scoring engine calculates a patient score according to an arithmetic mean, a geometric mean, a weighted arithmetic mean, or a weighted geometric mean.

16. The system of claim 11, wherein the second remote computer system comprises computer media owned or leased by a medical practitioner.

17. The system of claim 11, wherein the scheduling engine further comprises a means for overriding the scheduling rules at the option of an authorized user of the system.
